(19) United States
(12) Patent Application Publication
(10) Pub. No.: US 2018/0024704 A1
(43) Pub. Date: Jan. 25, 2018

(54) STORAGE AND STRUCTURE OF EVENTS WITH INTENTIONAL-BASED TIME FOR CALENDAR APPLICATIONS

(71) Applicant: Microsoft Technology Licensing, LLC, Redmond, WA (US)

(72) Inventors: Fabio Andre PINTOS, Kirkland, WA (US); Thomas J. EYERMAN, JR., Redmond, WA (US)

(21) Appl. No.: 15/215,824

(22) Filed: Jul. 21, 2016

(51) Int. Cl. G06F 3/0482; G06F 3/0484

(52) U.S. Cl. CPC G06F 3/0482; G06F 3/04847

(57) ABSTRACT

Calendar events can be stored for calendar applications by providing a set of available intent-time options. When an input indicative of an event for a calendar item is received, an appropriate intent-time from the set of available intent-time options can be determined and any parameters suitable for the appropriate intent-time can be identified. The event can then be stored with a start property according to the appropriate intent-time and any of the parameters identified from the input. The set of available intent-time options can include a standard time option and one or more trigger-based time options such as astronomical phenomena-based time and tide-based time.

### BACKGROUND

A calendar file format such as iCalendar uses calendar objects with a body indicating calendar properties and calendar components that specify events, for example. An event can be described in the calendar file format with a start time property and an end time property. Of course, in some cases there may not be a specific time for an event; rather, just a date is used. Other properties can be included to describe the event, including a summary and/or description property that may contain descriptive text provided, for example, via a subject line and body of a calendar item. Extensions for the calendar file format can permit any number of additional properties to be included.

Calendar applications currently store time as a date and a time of day. For example, Google uses a structure for events in the form of “start”: {“date”: date, “dateTime”: datetime, “timeZone”: string}. As another example, Microsoft Office 365 uses DateTimeTimeZone, which describes the date, time, and time zone of a point in time as “DateTime”: DateTime (a single point of time in a combined date and time representation), “TimeZone”: string. Any information on the underlying purpose of a particular date and time (other than that entered as descriptive text in the item by the user) would not be stored in the current date and time format. For example, a sunset time would be stored as a date/time by the calendar application without necessarily providing the date and time's association with the underlying event—the sunset for that day and location—from which that time was originally obtained.

### BRIEF SUMMARY

Storage and structure of events with intentional-based time for calendar applications are described. An intentional-based time is provided in which the date and time of an event is stored in an intent-time format.

Calendar events for calendar applications can be stored by providing a set of available intent-time options. When an input indicative of an event for a calendar item is received, the input can be classified to determine an appropriate intent-time from the set of available intent-time options. Any parameters suitable for the appropriate intent-time may be identified from the input, and the event can be stored with start and end properties according to the appropriate intent-time and the parameters identified from the input. The intent-time can preserve the underlying intent of why the event is scheduled at a certain time.

The underlying intents of events stored in association with users' calendars can be accessed through the calendar applications by extracting information from the start and end properties of an event to determine a corresponding intent-time for the event. An identifier may be provided to indicate the particular intent-time from the available intent-times provided by the calendar application. In some cases, when available, one or more parameters originally identified from an original input creating the event and which are stored with the properties of the event can be provided.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a process that may be carried out by a calendar application for storing calendar events.

FIG. 2 illustrates a process utilizing the described storage and structure of calendar events.

FIGS. 3A-3B illustrate an example scenario in which the process of FIG. 2 may be carried out.

FIG. 4 illustrates a calendar request and example storage structure.

FIGS. 5A and 5B present block diagrams illustrating components of systems that may be used to implement the techniques described herein.

FIG. 6 illustrates an example system architecture in which the described systems and techniques may be carried out.

### DETAILED DESCRIPTION

Storage and structure of events with intentional-based time for calendar applications are described. An intentional-based time is provided in which the date and time of an event is stored in an intent-time format. Not only does an intent-time format allow for more detailed storage of information in a manner that can be easier to manipulate, quantify, and access, the intent-time format also retains information about the underlying intent for an event so that when queried, the calendar application can indicate at least what the start time or end time for an event is based on.

A calendar application may include components that are local (at a user's device) and components that are residing on a server, which can provide access and syncing of calendar items across multiple devices and/or storage of the user's calendar items. In some cases, the calendar application is part of a larger personal information management service that forms a coordinated storage system for more than one user. In various implementations, the calendar application may be a rich client on a desktop or laptop (e.g., Microsoft Outlook®), a mobile client on a mobile device (e.g., a calendar application on the Android OS®, iCal for iOS®, Outlook® for Windows Phone®, or Cal from Any.do), or part of an application running as cloud services accessible via a web browser (e.g., Google® Calendar, Microsoft® Outlook Web App (OWA)).

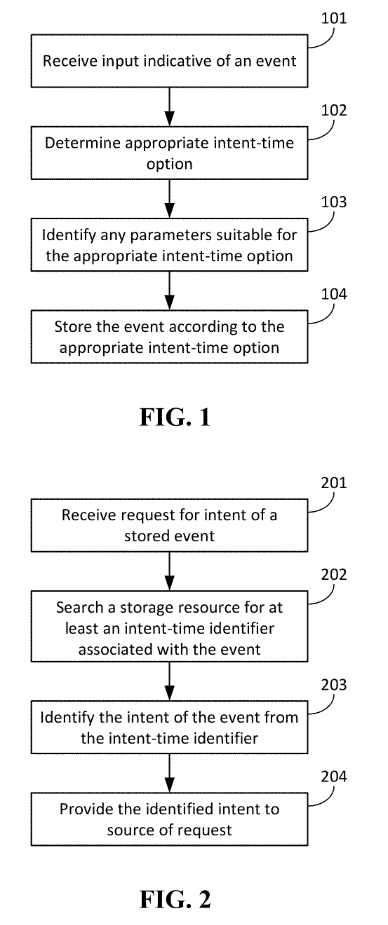

FIG. 1 illustrates a process that may be carried out by a calendar application for storing calendar events. A system supporting a calendar application (e.g., a system that stores user's calendar items for access across multiple platforms) can facilitate intentional-based time by providing a set of available intent-time options. The set can include a standard time option (e.g., a start time without a trigger) and at least one trigger-based time. A trigger refers to an event or occurrence upon which the actual time is based. While location may contribute to the time of the trigger event, a trigger-based time does not refer to simply a change in time zone (as that is considered one of the standard time options).

When anew event is being created, an input indicative of an event for a calendar item is received (101) by the calendar application. An input is considered indicative of an event for a calendar item if it can be categorized or understood by the system to contain information relevant to an event. This information generally pertains to a date and time and often includes a subject as well as other information that a user describes an event. The system may understand that a new event is being created through an explicit command (e.g., via an icon in a user interface) or implicit command (e.g., via input—textual or verbal—indicating that something is being scheduled) to create a new calendar event.

The input can be a natural language string received through, for example, a keyboard input (e.g., touch screen keyboard, mouse, keyboard) or a verbal input (e.g., via a personal assistant such as Cortana®, Siri®, Echo®). A chatbox interface (for keyed or verbal input) can be provided as part of the calendar application (or even as part of an operating system or personal digital assistant that can communicate with the calendar application). In some cases, a form may be used to receive an explicit input of the parameters for a particular intent-time.

Once the input indicative of an event for a calendar item is received (101), the input is analyzed to determine an appropriate intent-time option (102). The appropriate intent-time option may be determined by classifying the input against the available intent-time options to identify an appropriate intent-time from the available intent-time options so that the underlying intent described by the input can be saved. The classification can be made against possible intentional times using the terms (and any recognizable entities) from the descriptions of the time for the event. In addition to identifying intent of an input, an offset, condition, or both may also be identified and stored as properties (or parameters) of the event. For example, the system can store conditions such as “I want to do this if it is not raining”. Thus, the input can be analyzed to identify any parameters suitable for the appropriate intent-time option (103).

The appropriate intent-time can be determined using, for example, an intent mapping processor. An intent mapping processor can include a classifier or state machine to identify, from a target, a most relevant intentional time option. Sometimes more than one option may be identified (or no options are found that reach a certain threshold of relevancy). In those cases, a workflow may initiate to request additional information from the user or other types of suitable processes may be carried out to identify the appropriate intent-time format. The intent mapping processor can also include a slot filler for parameter intents. The slot filler may be used to extract information and even relationships for classifying and/or identifying the appropriate intent-time (and its parameters). Accordingly, a slot filler evaluation can be performed as part of or during the classifying step.

The classification activities (and other processes) may be carried out by a calendar application executed locally on a computing device or executed at a server as part of a web-based calendar application (or for a thin client calendar application).

The available intent-time formats can include two or more of standard time (e.g., the start time, end time, time zone format), astronomical-based times (e.g., sunrise, sunset, moonrise, moonset), and tide-based times (e.g., high tide, low tide). Other types of intentional times are contemplated such as, but not limited to, sporting event-based time (e.g., time based on the beginning or end time of a sporting event like a baseball game or a football game, which may vary over the course of a season) and even transport-based time (e.g., time based on departure or arrival of an airplane or train schedule).

For the sporting event-based time, the system can look up a sport calendar (during execution of the calculation when presenting the event in a UI of the calendar application) and identify the time a specified game starts and/or ends on the specified day. As an illustration, if a user input is “I want to eat dinner after the Mariner's game”, the system can look up the time the game is scheduled to finish (e.g., by using an index to a sport calendar) and apply an offset to arrive, for example, at a time of 8 pm. The system does not store the time as 8 pm, but rather in sport time format (which results in the system performing the calculation when the particular view of the calendar is requested). Since the event is stored as sport time format, the underlying intent (to schedule a dinner around a sporting event) can be retained. Thus, if that user (or another user with permissions to the user's calendar) later wonders why there is a dinner scheduled for that late in the day or moves the dinner to another date, the reason for the time can be understood and adjusted accordingly.

In addition to or as part of standard time format, existing properties can be leveraged for intentional time. For example, a “wall clock” property that enables a user to set a start time for an event that is not dependent on time zone can be identified when classifying a user input. As an illustration, if a user input is “I want to have breakfast at 9 am on the 24th” then the system can determine that the intentional time is a “wall clock” time and should show up on the user's calendar as 9 am regardless of the time zone that the user was in at the time of scheduling the event. In this manner, if the user views a calendar that is time-adjusted for a visit to China, the event will still appear as 9 am on their calendar even if the original input was given while they were in Kirkland, Wash.

Once the appropriate intent-time is identified, the event can be stored according to the format for that intent-time (104). For example, instead of only having an event described by a date and an exact time of the day when stored by a calendar application, the type of the Start property of an Event is an abstract class that allows derived classes to specify different parameters, and each derived class can calculate the exact time based on its own characteristics. In this manner, the event can be stored with a start property according to the appropriate intent-time and any of the parameters identified from the input. Of course, in addition to “start”, the “end” can be calculated and/or identified.

An event can be stored as class Event, which has a property to indicate the intentional time, which may be in addition to or take the place of the traditional “Start” date time. The intentional time can be used to store the original parameters passed by the end user. These parameters can be used to rebuild user interfaces with correct information (when viewed in a day, week, month, or other calendar view) and to calculate the exact times of recurring events in different dates. The information about the intentional time (and the stored parameters) can also be searched to manipulate (e.g., sort) events, quantify (e.g., perform analytics on) events, and access the underlying intents of the events.

The underlying intents of events stored in association with users' calendars can be accessed through the calendar applications by extracting information from the properties of an event to determine a corresponding intent-time for the event. When the time of an event is read, the type of intent-time can be determined. An identifier may be provided to indicate the particular intent-time from the available intent-times provided by the calendar application. The identifier may be stored as a property of the event. The identifier may be a human readable name of the type of intent-time or data that is used to map to a human readable name of the type of intent-time (e.g., a user-readable trigger that indicates the intent). In some cases, when available, one or more parameters originally identified from an original input creating the event and which are stored with the properties of the event can be provided.

FIG. 2 illustrates a process utilizing the described storage and structure of calendar events. Referring to FIG. 2, a system can receive a request for intent of a stored event (201). The source of the request may be a client calendar application or some other application or service that desires to access, manipulate, or quantify (e.g., for analysis) the event information. The request can include an event identifier, which is used to search a storage resource storing the events for the intent-time identifier associated with the event (202). The intent of the event may be identified from the intent-time identifier (203) directly (e.g., because the intent-time identifier is in a form that is user-readable) or indirectly (e.g., where the intent-time identifier can be mapped to a user-readable form). The identified intent can be provided to the source of the request (204). For example, a request for the type of intent-time may be made to the calendar application. The calendar application can extract or otherwise read the identifier and provide the human readable name of the type of intent-time. This information could be displayed to a user in response to a certain interaction with an event displayed on a user's calendar that is understood by the application to indicate a request for the type of intent-time.

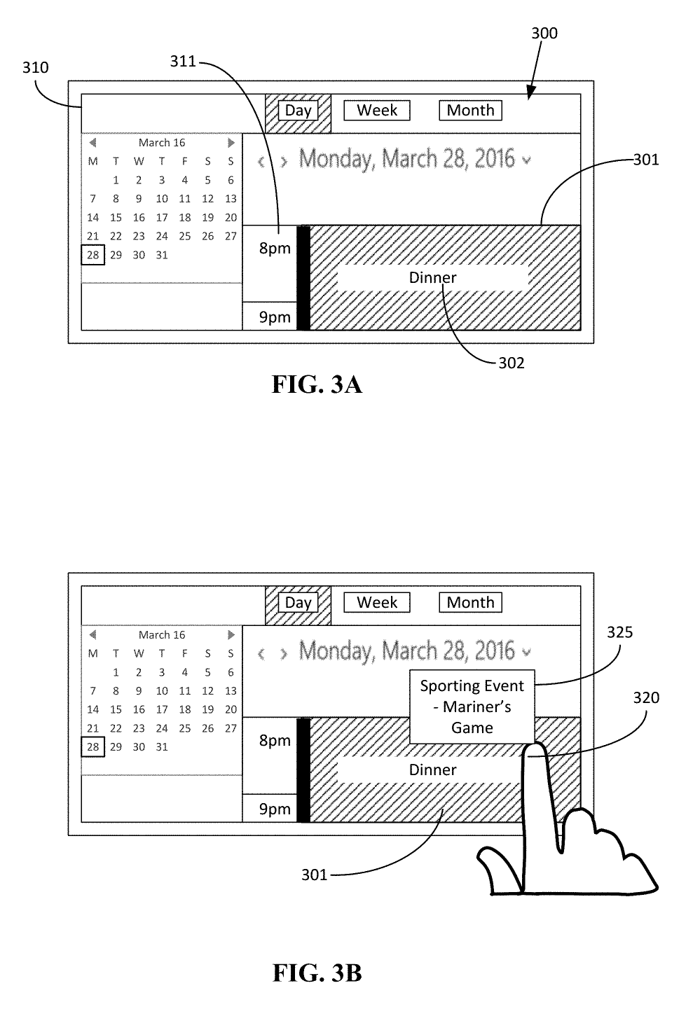

FIGS. 3A and 3B illustrate an example scenario in which the process of FIG. 2 may be carried out. For example, as shown in FIG. 3A, an event 301 labeled “dinner” 302 is shown in a user's calendar 310 starting at a time 311 noted as 8 pm in the graphical user interface 300. An interaction, such as the user hovering over the event with a curser or the user touching (320) a portion of the event 301 as shown in FIG. 3B, may be used to indicate a request for the type of intent-time; and, therefore, in response to receiving the indication (by the user hovering over or touching the event), the calendar application reads the identifier and provides the human readable description of the type of intent-time, which in this example is sporting event-based time (e.g., via the process described with respect to FIG. 2). The resultant information can be presented to the user in a window 325 such as shown in FIG. 3B or in place of the event subject (not shown) or in some other suitable manner. Parameters such as “Mariner's game” may have been stored with the start time associated with the sporting event-based time and this information also provided to the user to provide additional information as to what sporting event the time is based on.

Accordingly, not only does an intent-time format allow for more detailed storage of information in a manner that can be easier to manipulate, quantify, and access, the intent-time format also retains information about the underlying intent for an event so that when queried, the calendar application can indicate at least what the start time for an event is based on.

The following examples of events for calendar applications with intent-time structures are shown in a pseudo-code/pseudo-language.

In one example, an event can be represented as: class Event{ . . . string Subject; EventTime StartTime; DateTimeOffset Start; . . . }.

The EventTime represents the actual time of an event; it is an abstract type, since time can now be represented in different ways. The actual time of an event becomes an offset based on the time in which the event is triggered. The time in which the event is triggered can be based on any number of things including natural phenomena.

The EventTime can be represented as:

abstract class EventTime { TimeSpan Offset; DateTimeOffset
GetActualTime(DateTimeOffset date) {Return
this.GetTriggerTime(date) + this.Offset; }
abstract DateTimeOffset GetTriggerTime(DateTimeOffset date);}.

It should be noted that the TimeSpan property referred to as the Offset is independent of the “reminder” of an event; it serves to set how much time before or after the trigger the event will happen. If the offset is positive, it indicates time AFTER the trigger. If the offset is negative, it indicates time BEFORE the trigger. If the offset is zero, the event time will be the same as the trigger. GetActualTime returns the actual time of the event on the given date and the GetTriggerTime returns the time of the trigger on the given date.

The intentional time represented by the EventTime may be a fixed time (or standard time format), which can be represented in the traditional way with a fixed date, time and time zone. The pseudo-language representation can be class FixedTime: EventTime{DateTimeOffset DateTime; override DateTimeOffset GetTriggerTime(DateTimeOffset date) {return this.DateTime;}}. On a fixed time, the trigger time (in the function) is whatever was specified by the user so there is no offset.

Sometimes the actual time of an event varies by location. For handling those types of events, the EventTime can be represented as abstract class LocationBasedTime: EventTime{GeographyPoint Location; String LocationName;}.

The GeographyPoint Location is the geographic point (latitude, longitude) that should be used when calculating the time of the event. The String LocationName refers to a human readable description of the location, to be used by user interfaces.

There are a number of astronomical phenomena that the system can support, for example, enum AstronomicalPhenomena{Sunrise, SolarNoon, Sunset, Moonrise, Moonset,}. Thus, for an actual time of an event that varies based on astronomical phenomena (which is also a time that varies by location, the AstronomicalEventTime can be represented as class AstronomicalEventTime: LocationBasedTime {AstronomicalPhenomena Phenomena; DateTimeOffset GetTriggerTime(DateTimeOffset date) {return GetTimeOfAstronomicalPhenomena(date, this.Phenomena, this.Location);}}.

The AstronomicalPhenomena Phenomena describes the type of astronomical calculation the event will perform (the “Phenomena” is an indicator of which astronomical phenomena used). The GetTriggerTime calculation identifies the time when the specified astronomical phenomenon happens at the specified location.

Another naturally varying time is based on the tides. As an example, the system can support enum TidePhenomena {FirstHighTide, FirstLowTide, SecondHighTide, SecondLowTide}. Thus, for an actual time of event that varies based on the tides (which is also a time that varies by location), the TideEventTime can be represented as class TideEventTime: EventTime{String StationName; TidePhenomena Phenomena; DateTimeOffset GetTriggerTime(DateTimeOffset date) {return GetTidePhenomenaTime(date, this. Phenomena, this. StationName);}}.

The StationName is the name of the station that provides tide levels. The TidePhenomena Phenomena describes the type of tide calculation the event will have. The GetTriggerTime calculation identifies when the specified tide happens at the specified location (based on the station name).

Traditional fixed-time events can be created, for example as follows (in pseudo-language):

event = new Event( );
event.StartTime = new FixedTime { DateTime =
fixed_time_as_entered_by_user } }
event.Start =
event.StartTime.GetActualTime(fixed_date_and_time_as_entered_by_user);
...

In the case of recurring events, the “Start” of each recurrence gets calculated by calling event. StartTime.GetActualTime with the date of each particular recurrence instance. Since recurrences can be infinite, the system only needs to calculate the “Start” of each instance when calendaring clients request a calendar view from the system. On the other hand, events whose time depends on astronomical phenomena (or other non-pattern recurring events) are created with the other classes (for intent-based time).

The following provide example scenarios and corresponding event structures for new events.

Story 1: John is in a camping trip. He wants to watch the sunrise, so he asks Cortana to ‘wake me up half-an-hour before sunrise’. Cortana knows today's date and the latitude and longitude where John is, based on the location of his device, and creates a calendar event with the relative time of “Tomorrow, 0:30 m BEFORE SUNRISE @ (lat,long)”. This becomes:

event = new Event( );
event.StartTime= new AstronomicalEventTime { Offset =
TimeSpan.FromMinutes(−30), Phenomena =
AstronomicalPhenomena.Sunrise, Location = GeoLocation.Create(lat,
lon) }
event.Start =
event.StartTime.GetActualTime(DateTime.Now.Date.AddDays(1)) .

Story 2: Kate lives in Kirkland and wants to be home before sundown every Friday. She creates a recurring Event in a calendar application with the relative time “Every Friday, 1 H BEFORE SUNSET @ Kirkland, Wash.”. Every occurrence of this event happens in a different time, depending on the day of the year, but Kate does not need to manually calculate them; the system simply sets up each occurrence with the correct time. In this case, the system could use a geolocation service such as available from Bing or Google to resolve the human expression of location to a set of coordinates, and store that in the event.

event = new Event( );
event.Recurrence = new WeeklyRecurrencePattern { DaysOfWeek
=(Friday) }
event.StartTime= new AstronomicalEventTime { Offset =
TimeSpan.FromHours(−1),
Phenomena = AstronomicalPhenomena.Sunset, LocationName =
“Kirkland, WA”,
Location = GetCoordinates(“Kirkland, WA”) }

It should be noted that in this case, the system does not need to pre-calculate a “Start” time; each instance of the occurrence will have its own time. When providing a calendar view, the system can calculate the exact time of each occurrence by calling: event.StartTime.GetActualTime(day_of_the_occurence).

Story 3: Peter wants to go see the tide pools when the tide is low, so he creates a new event in his calendar with the relative time of “Tomorrow, 15 minutes BEFORE LOW MORNING TIDE @ Deception Pass, WA”.

event = new Event( );
event.StartTime= new TideEventTime { Offset =
TimeSpan.FromMinutes(−15),
Phenomena = TidePhenomenaFirstLowTide, LocationName = “Deception
Pass, WA”, Location = GetCoordinates(“Deception Pass, WA”) }
event.Start =
event.StartTime.GetActualTime(DateTime.Now.Date.AddDays(1)) .

As can be seen from the examples, intent-time is polymorphic in that time is described in different ways. An event's time (e.g., EventTime) can hold one or more parameters that do not map to something fixed and instead use an underlying formula/function that, for a given day, can be calculated to determine the time of the event at that day. These functions can be calculated at a server or at a client device, depending on the complexity.

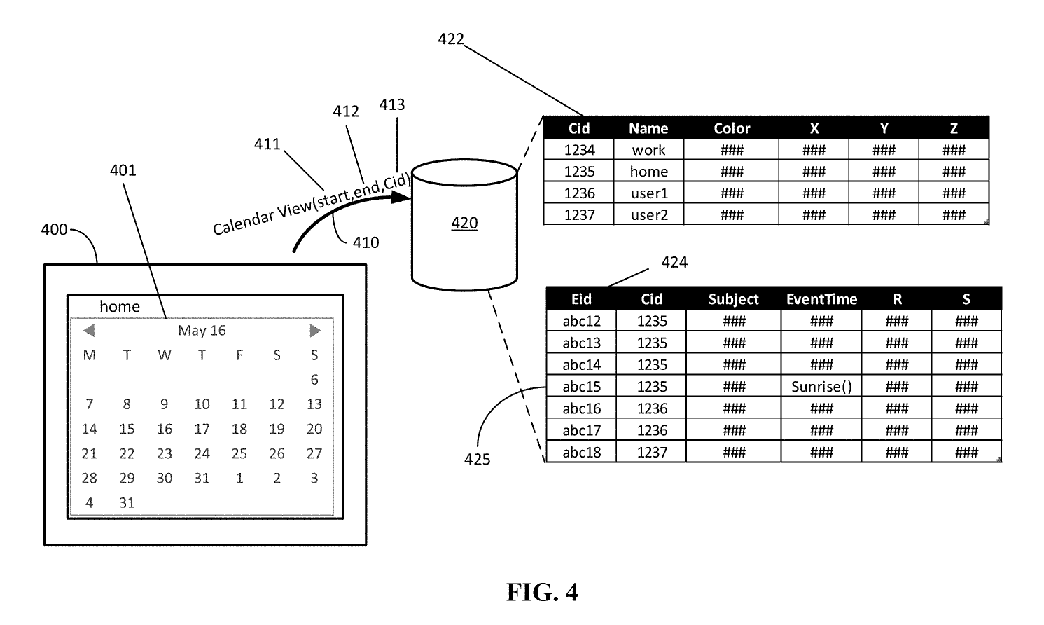

FIG. 4 illustrates a calendar request and example storage structure. Referring to FIG. 4, when a user selects to view a calendar 401, the client calendar application at a user computing device 400 requests (410) a calendar view from a storage resource 420 (or server managing the storage resource). The request 410 can include a start date 411, an end date 412, and a calendar identifier (Cid) 413. The start and end date refer to the dates available in the particular view the user would like to see (e.g., May 1 to May 31 in the example). The calendar service identifies the calendar from the calendar id in the structured data (e.g., calendar database 422) stored at the storage resource 420 and populates the calendar with the events associated with that calendar id (e.g., from event database 424). The calendar application receives the events that fall within the requested date range. These events may include an intent-time-based event (which is indicated by the object EventTime). For example, in this illustration, if the Cid was the user's home calendar, a sunrise-based time event 425 is included in the events. In order to display the calendar view, the client calendar application may calculate the time or the service may calculate the time so that the event displays at the appropriate time in the user's calendar.

In one implementation, the object intent-time (or “EventTime”) can have a number of classes that derive from that object. One class can be standard time (containing the normal date and time information) and another class can be location-based time, which can include properties of latitude and longitude. In the location-based time, the subclasses can include, but are not limited to, sunset, sunrise, moonset, and moonrise. Another class can be tide-based time, which can contain a property of naval station name (which is an index to a tide table).

The calculation for location-based time may be a function which can be carried out, in some cases, at a client device. Example calculations include, for sunrise or sunset calculating a current day, mean solar noon, solar mean anomaly, equation of the center, ecliptic longitude, solar transit, declination of the Sun, hour angle, and finally sunrise and sunset using the actual Julian date of sunset/sunrise and solar transit in view of the hour angle. In some cases, an API may be called, which also may provide times for solar noon, civil twilight begin, civil twilight end, nautical twilight begin, nautical twilight end, astronomical twilight begin, astronomical twilight end.

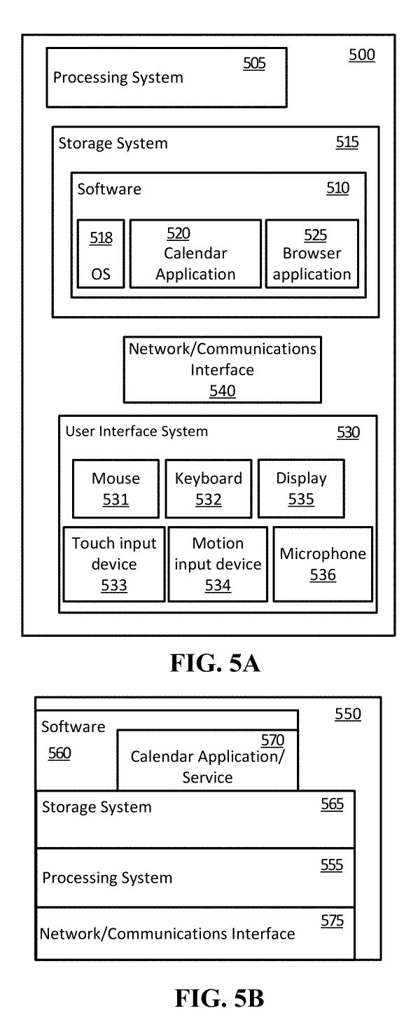

FIGS. 5A and 5B present block diagrams illustrating components of systems that may be used to implement the systems and techniques described herein.

Referring to FIG. 5A, system 500 may represent a computing device such as, but not limited to, a personal computer, a tablet computer, a reader, a mobile device, a personal digital assistant, a wearable computer (e.g., in the form of a watch, glasses, apparel), a smartphone, a laptop computer (notebook or netbook), a gaming device or console, a desktop computer, or a smart television. Accordingly, more or fewer elements described with respect to system 500 may be incorporated to implement a particular computing device.

System 500, for example, includes a processing system 505 of one or more processors to transform or manipulate data according to the instructions of software 510 stored on a storage system 515. Examples of processors of the processing system 505 include general purpose central processing units, application specific processors, and logic devices, as well as any other type of processing device, combinations, or variations thereof.

Storage system 515 may comprise any computer readable storage media readable by the processing system 505 and capable of storing software 510 including the calendar application 520 and/or browsing application 525.

Storage system 515 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is a storage medium a propagated signal or carrier wave.

Storage system 515 may be implemented as a single storage device but may also be implemented across multiple storage devices or sub-systems co-located or distributed relative to each other. Storage system 515 may include additional elements, such as a controller, capable of communicating with processor 505.

Software 510 may be implemented in program instructions and among other functions may, when executed by system 500 in general or processing system 505 in particular, direct system 500 or the one or more processors of processing system 505 to operate as described herein.

The software 510 can include an operating system 518 and application programs such as a calendar application 520 and/or web browsing application 525. In some cases, the software 510 can include an intent mapping processor (with classifier and/or slot filler). A device operating system 518 generally controls and coordinates the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system 518 may be implemented both natively on the computing device and on software virtualization layers running atop the native device operating system (OS). Virtualized OS layers, while not depicted in FIG. 5A, can be thought of as additional, nested groupings within the operating system space, each containing an OS, application programs, and APIs.

In general, software may, when loaded into processing system 505 and executed, transform computing system 500 overall from a general-purpose computing system into a special-purpose computing system customized as described herein for each implementation. Indeed, encoding software on storage system 515 may transform the physical structure of storage system 515. The specific transformation of the physical structure may depend on various factors in different implementations of this description. Examples of such factors may include, but are not limited to the technology used to implement the storage media of storage system 515 and whether the computer-storage media are characterized as primary or secondary storage.

The system can further include user interface system 530, which may include input/output (I/O) devices and components that enable communication between a user and the system 500. User interface system 530 can include input devices such as a mouse 531, track pad (not shown), keyboard 532, a touch device 533 for receiving a touch gesture from a user, a motion input device 534 for detecting non-touch gestures and other motions by a user, a microphone 536 for detecting speech, and other types of input devices and their associated processing elements capable of receiving user input.

The user interface system 530 may also include output devices such as display screens 535, speakers (not shown), haptic devices for tactile feedback (not shown), and other types of output devices. In certain cases, the input and output devices may be combined in a single device, such as a touchscreen display which both depicts images and receives touch gesture input from the user. Visual output may be depicted on the display 535 in myriad ways, presenting graphical user interface elements, text, images, video, notifications, virtual buttons, virtual keyboards, or any other type of information capable of being depicted in visual form.

The user interface system 530 may also include user interface software and associated software (e.g., for graphics chips and input devices) executed by the OS in support of the various user input and output devices. The associated software assists the OS in communicating user interface hardware events to application programs using defined mechanisms. The user interface system 530 including user interface software may support a graphical user interface, a natural user interface, or any other type of user interface. For example, the calendar views and calendar event creation and searching described herein may be presented through user interface system 530.

Communications interface 540 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 518, which informs applications of communications events when necessary.

It should be noted that many elements of system 500 may be included in a system-on-a-chip (SoC) device. These elements may include, but are not limited to, the processing system 505, a communications interface 540, and even elements of the storage system 515.

Computing system 500 is generally intended to represent a computing system with which software is deployed and executed in order to implement an application, component, or service for a calendar application as described herein. In some cases, aspects of computing system 500 may also represent a computing system on which software may be staged and from where software may be distributed, transported, downloaded, or otherwise provided to yet another computing system for deployment and execution, or yet additional distribution.

Certain aspects described herein may be carried out on a system such as shown in FIG. 5B. Referring to FIG. 5B, system 550 may be implemented within a single computing device or distributed across multiple computing devices or sub-systems that cooperate in executing program instructions. The system 550 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 550 can include a processing system 555, which may include one or more processors and/or other circuitry that retrieves and executes software 560 from storage system 565. Processing system 555 may be implemented within a single processing device but may also be distributed across multiple processing devices or sub-systems that cooperate in executing program instructions.

Examples of processing system 555 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

As with storage system 515 of FIG. 5A, storage system 565 can include any computer readable storage media readable by processing system 555 and capable of storing software 560. Storage system 565 may be implemented as a single storage device but may also be implemented across multiple storage devices or sub-systems co-located or distributed relative to each other. Storage system 565 may include additional elements, such as a controller, capable of communicating with processing system 555.

In some cases, storage system 565 includes one or more storage resources in which calendar information is stored.

Software 560 may be implemented in program instructions and among other functions may, when executed by system 550 in general or processing system 555 in particular, direct the system 550 or processing system 555 to operate as described herein for storing and retrieving calendar events. Software 560 may provide program instructions that embody a calendar application or service 570 implementing the described storage and structure of calendar events.

Software 560 may also include additional processes, programs, or components, such as operating system software or other application software. Software 560 may also include firmware or some other form of machine-readable processing instructions executable by processing system 555.

System 550 may represent any computing system on which software 560 may be staged and from where software 560 may be distributed, transported, downloaded, or otherwise provided to yet another computing system for deployment and execution, or yet additional distribution.

In embodiments where the system 550 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 575 may be included, providing communication connections and devices that allow for communication between system 550 and other computing systems (not shown) over a communication network or collection of networks (not shown) or the air.

It should be noted that many elements of system 550 may be included in a SoC device. These elements may include, but are not limited to, the processing system 555, the communications interface 575, and even elements of the storage system 565.

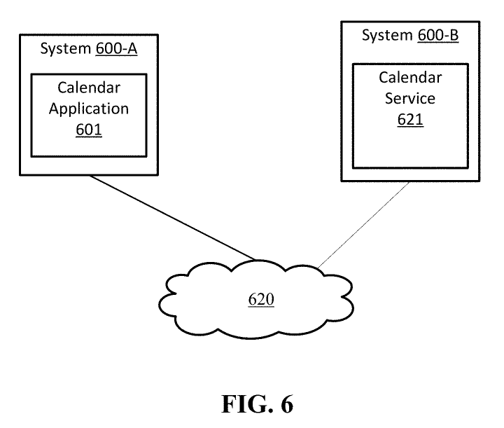

FIG. 6 illustrates an example system architecture in which the described systems and techniques may be carried out. Referring to FIG. 6, a calendar application 601 may be implemented on a computing system 600-A such as described with respect to system 500 of FIG. 5A. The user of the calendar application 601 may utilize the application to create, edit, or view a calendar event.

Calendar application 601 may communicate over network 620 with associated calendar service(s) 621 contained on system 600-B, which is a particular instance of system 550 described in FIG. 5B. Calendar service(s), of which there may be several types, vendors or providers, and access methods, may be embodied in data structures and processing functions allowing accessibility and interchange with calendar applications 601.

Calendar application 601 and/or calendar service 621 may in some instances communicate with services providing trigger information (e.g., sunrise/sunset times) using application programming interfaces (APIs) to send requests and receive information.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. An API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic.

The API-calling component may be a local component (i.e., on the same data processing system as the API-implementing component) or a remote component (i.e., on a different data processing system from the API-implementing component) that communicates with the API-implementing component through the API over a network. An API is commonly implemented over the Internet such that it consists of a set of Hypertext Transfer Protocol (HTTP) request messages and a specified format or structure for response messages according to a REST (Representational state transfer) or SOAP (Simple Object Access Protocol) architecture.

The network 620 can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of storing calendar events for calendar applications, the method comprising:
providing a set of available intent-time options;
receiving an input indicative of an event for a calendar item;
in response to receiving the input, determining an appropriate intent-time from the set of available intent-time options;
identifying from the input any parameters suitable for the appropriate intent-time; and
storing the event with a start property according to the appropriate intent-time and any of the parameters identified from the input.

2. The method of claim 1, wherein providing the set of available intent-time options comprises providing at least a standard time and one or more trigger-based times.

3. The method of claim 2, wherein the appropriate intent-time is determined to be a standard time.

4. The method of claim 1, wherein the appropriate intent-time is determined to be an astronomical-based time, wherein storing the event with the start property according to the appropriate intent-time comprises:
storing an astronomical phenomena indicator and a location data for the start property.

5. The method of claim 1, wherein the appropriate intent-time is determined to be a tide-based time, wherein storing the event with the start property according to the appropriate intent-time comprises:
storing an index to a tide table for the start property.

6. The method of claim 1, wherein the appropriate intent-time is determined to be a sporting event-based time, wherein storing the event with the start property according to the appropriate intent-time comprises:
storing an index to a sport calendar for the start property.

7. A calendaring system comprising:
a processing system;
a storage system;
structured calendar data stored on a storage resource of the storage system, the structured calendar data comprising, for each event, at least a corresponding event identifier, a calendar identifier indicating a corresponding calendar to which the event belongs, and a corresponding intent-time identifier;
instructions for supporting a calendar application stored on the storage system, the instructions directing the processing system to at least:
receive a request, from a source, for an intent of an event stored as part of a calendar, the request comprising at least an event identifier for the event;
search a storage resource storing the event for at least an intent-time identifier associated with the event;
identify the intent from the intent-time identifier; and
provide the intent identified from the intent-time identifier to the source of the request.

8. The system of claim 7, wherein the instructions further direct the processing system to provide one or more parameters associated with the intent-time identifier to the source of the request.

9. The system of claim 7, wherein the corresponding intent-time identifier indicates one of at least a standard time and one or more trigger-based times.

10. The system of claim 7, wherein the instructions that provide the intent identified from the intent-time identifier direct the processing system to at least:
communicate a user-readable trigger as the intent.

11. The system of claim 7, wherein the user-readable trigger indicates a standard time option.

12. The system of claim 7, wherein the user-readable trigger indicates an astronomical-based time option.

13. The system of claim 7, wherein the user-readable trigger indicates a tide-based time option.

14. The system of claim 7, wherein the user-readable trigger indicates a sporting event-based option.

15. One or more computer-readable storage media having instructions stored thereon that, when executed by a processing system, direct the processing system to at least:
provide a set of available intent-time options;
receive an input indicative of an event for a calendar item;
determine an appropriate intent-time from the set of available intent-time options;
identify from the input any parameters suitable for the appropriate intent-time;
store the event, in a storage resource, with a start property according to the appropriate intent-time and any of the parameters identified from the input; and
in response to receiving a request, from a source, for an intent of the stored event, the request comprising at least an event identifier for the stored event:
search the storage resource for at least an intent-time identifier associated with the event;
identify the intent from the intent-time identifier; and
provide the intent identified from the intent-time identifier to the source of the request.

16. The media of claim 15, wherein the instructions further direct the processing system to, in response to receiving the request, provide one or more parameters of any of the parameters identified from the input to the source of the request.

17. The media of claim 15, wherein providing the set of available intent-time options comprises providing at least a standard time and one or more trigger-based times.

18. The media of claim 15, wherein the appropriate intent-time is determined to be a standard time, the intent identified from the intent-time identifier indicating a standard time option.

19. The media of claim 15, wherein the appropriate intent-time is determined to be an astronomical-based time, wherein the event is stored with an astronomical phenomena indicator and a location data for the start property, the intent identified from the intent-time identifier indicating an astronomical-based option.

20. The media of claim 15, wherein the appropriate intent-time is determined to be a tide-based time, wherein the event is stored with an index to a tide table for the start property, he intent identified from the intent-time identifier indicating a tide-based option.
